(19) United States
(12) Patent Application Publication
(10) Pub. No.: US 2018/0367768 A1
(43) Pub. Date: Dec. 20, 2018

(54) PROJECTION SYSTEM, PROJECTOR, AND METHOD FOR CONTROLLING PROJECTION SYSTEM

(71) Applicant: SEIKO EPSON CORPORATION, Tokyo (JP)

(72) Inventor: Tatsuhiko NOBORI, Matsumoto-Shi (JP)

(73) Assignee: SEIKO EPSON CORPORATION, Tokyo (JP)

(21) Appl. No.: 15/996,885

(22) Filed: Jun. 4, 2018

(30) Foreign Application Priority Data
Jun. 19, 2017 (JP) 2017-119376

(51) Int. Cl. H04N 9/31; H04N 5/04; H04N 5/60

(52) U.S. Cl. CPC H04N 9/3147; H04N 5/60; H04N 5/04

(57) ABSTRACT

A projection system includes a plurality of projectors connected in a daisy chain. Each of the projectors includes: an input unit to which an image signal and an audio signal is inputted; an audio output unit which outputs a sound based on the audio signal inputted to the input unit; a signal output unit which outputs the image signal and the audio signal to the projector placed subsequently in an order of connection; and a delay information output unit which outputs delay information representing a delay in the projector to the other projectors. At a timing corresponding to a delay in one of the projectors forming the daisy chain, one or more of the other projectors cause the audio output unit to output a sound based on the audio signal.

### CROSS-REFERENCE

The entire disclosure of Japanese Patent Application No. 2017-119376, filed Jun. 19, 2017 is expressly incorporated by reference herein.

### BACKGROUND

### 1. Technical Field

The present invention relates to a projection system, a projector, and a method for controlling a projection system.

### 2. Related Art

According to the related art, a projection system has been known in which a plurality of projectors is connected via a cable and in which the plurality of projector thus connected projects an image (see, for example, JP-A-2015-154370). JP-A-2015-154370 discloses a multi-projection system including a plurality of projectors capable of outputting a sound based on stereo audio data.

Incidentally, in a projection system having a plurality of projectors daisy-chained, a preceding projector sequentially transmits an audio signal to the subsequent projector. Therefore, the timing when the audio signal is inputted to each projector differs. This may cause a lag between the sounds outputted from the respective projectors.

### SUMMARY

An advantage of some aspects of the invention is that a lag between the sounds outputted from respective projectors is restrained in a projection system having a plurality of projectors daisy-chained.

An aspect of the invention is directed to a projection system including a plurality of projectors connected in a daisy chain. Each of the projectors includes: an input unit to which an image signal and an audio signal are inputted; a projection unit which projects an image based on the image signal inputted to the input unit; an audio output unit which outputs a sound based on the audio signal inputted to the input unit; a signal output unit which outputs the image signal and the audio signal inputted to the input unit, to the projector placed subsequently in an order of connection; and a delay information output unit which outputs delay information representing a delay in the projector to the other projectors. At a timing corresponding to a delay in one of the projectors forming the daisy chain, one or more of the other projectors cause the audio output unit to output a sound based on the audio signal.

According to the aspect of the invention, the timing when one or more of the other projectors output a sound can be made coincident with the timing when one of the projectors outputs a sound. Thus, a lag between the sounds outputted from the respective projectors can be restrained.

Another aspect of the invention is directed to a projection system including a plurality of projectors connected in a daisy chain. Each of the projectors includes: an input unit to which an image signal and an audio signal are inputted; a projection unit which projects an image based on the image signal inputted to the input unit; an audio output unit which outputs a sound based on the audio signal inputted to the input unit; a signal output unit which outputs the image signal and the audio signal inputted to the input unit, to the projector placed subsequently in an order of connection; and a delay information output unit which outputs delay information representing a delay in the projector to the other projectors. Each of the projectors causes the audio output unit to output a sound based on the audio signal, according to a time difference between a timing when the image signal is inputted to each of the projectors and a timing when the image signal is inputted to the projector placed last in the order of connection.

According to the aspect of the invention with this configuration, the timing when each of the projectors outputs a sound can be made coincident with the timing when the projector placed last in the order of connection outputs a sound. Thus, a lag between the sounds outputted from the respective projectors can be restrained.

In the aspect of the invention, each of the projectors may include an image processing unit which executes image processing on the image signal inputted to the input unit, and the delay information output unit may output the delay information reflecting a time taken for the processing executed by the image processing unit on the image signal inputted to the input unit.

According to the aspect of the invention with this configuration, a time reflecting the time taken for the processing executed by the image processing unit is outputted as the delay time. Therefore, the timing when each projector outputs a sound can be set, reflecting the time taken for the processing executed by the image processing unit.

In the aspect of the invention, the delay information output unit may output the delay information representing a time from when the image signal is inputted to the input unit to when the image signal is outputted by the signal output unit.

According to the aspect of the invention with this configuration, the time from when the image signal is inputted to the input unit to when the image signal is outputted by the signal output unit can be outputted to the other projectors. Therefore, the other projectors can find the time difference from the timing when the image signal is inputted to the last-placed projector, based on the time from when the image signal is inputted to the input unit to when the image signal is outputted by the signal output unit. Thus, a lag between the sounds outputted from the respective projectors can be restrained more effectively.

In the aspect of the invention, each of the projectors may include a delay detection unit which detects a delay time from when the image signal is inputted to the input unit to when the image signal is outputted by the signal output unit, and the delay information output unit may output the delay information representing the delay time detected by the delay detection unit.

According to the aspect of the invention with this configuration, the delay time from when the image signal is inputted to the input unit to when the image signal is outputted by the signal output unit can be detected in each projector.

In the aspect of the invention, one of the projectors may cause the delay information output unit to output the delay information representing a time resulting from adding a time from when the image signal is inputted to the input unit to when the image signal is outputted by the signal output unit, to a time represented by the delay information outputted from the projector that precedes in the order of connection.

According to the aspect of the invention with this configuration, the delay information reflecting the delay time of a preceding projector can be outputted to the subsequent projector.

In the aspect of the invention, one of the projectors may cause the delay information output unit to output the delay information to the projector placed first in the order of connection.

According to the aspect of the invention with this configuration, the first-placed projector can set the timing of outputting a sound, based on the delay information of the subsequent projector.

In the aspect of the invention, one of the projectors may output the delay information of each of the projectors except the projectors placed first and last in the order of connection, to the projector placed first in the order of connection.

According to the aspect of the invention with this configuration, the delay information of the projectors that is necessary for the first-placed projector to set the timing of outputting a sound can be inputted to the first-placed projector.

In the aspect of the invention, each of the projectors may include an image processing unit which executes image processing on the image signal inputted to the input unit, each of the projectors may be configured to be able to switch between and execute a plurality of operation modes with different contents of processing by the image processing unit, and each of the projectors may include a storage unit storing a table on which a delay time is registered for each order of connection and for each of the plurality of operation modes, and a control unit which causes the audio output unit to output a sound based on the audio signal inputted to the input unit, with the delay time corresponding to the order of connection and the operation mode of the image processing unit.

According to the aspect of the invention with this configuration, the audio output unit can be made to output a sound with the delay time corresponding to the order of connection and the operation mode of the image processing unit.

In the aspect of the invention, the projectors other than the projector placed last in the order of connection may output a sound, according to a timing when the last-placed projector outputs a sound based on the audio signal.

According to the aspect of the invention with this configuration, the timing when the projectors other than the last-placed projector output a sound can be made coincident with the timing when the last-placed projector outputs a sound.

In the aspect of the invention, the projectors next to each other may be arranged in such a way that images projected by the projection units are combined together on a projection surface.

According to the aspect of the invention with this configuration, image projected by the projects next to each other can be combined together on a projection surface.

In the aspect of the invention, images projected by a plurality of the projectors connected in a predetermined order of connection may be combined together on a projection surface.

According to the aspect of the invention with this configuration, images projected by a plurality of projectors can be combined together on a projection surface.

Still another aspect of the invention is directed to a projector that includes a projection unit which projects an image and includes: an input unit to which an audio signal is inputted; an audio output unit which outputs a sound based on the audio signal inputted to the input unit; a signal output unit which outputs the audio signal inputted to the input unit, to an external projector; a delay information output unit which outputs delay information representing a delay in the projector to the external projector; and an audio output control unit which decides, based on the delay information, a timing when the audio output unit and the external projector output a sound based on the audio signal.

According to the aspect of the invention, the timing when the audio output unit and the external projector output a sound is decided based on the delay information. Therefore, a lag between the sounds outputted from the projector and the external projector can be restrained.

Still another aspect of the invention is directed to a projector that includes a projection unit which projects an image and includes: an input unit to which an image signal and an audio signal are inputted; a projection unit which projects an image based on the image signal inputted to the input unit; an audio output unit which outputs a sound based on the audio signal inputted to the input unit; a signal output unit which outputs the image signal and the audio signal inputted to the input unit, to an external projector; and a delay information output unit which outputs delay information representing a delay in the projector to the external projector. The projector causes the audio output unit to output a sound based on the audio signal, according to a time difference between a timing when the image signal is inputted to the projector and a timing when the image signal is inputted to the external projector.

According to the aspect of the invention, the timing when the projector outputs a sound can be made coincident with the timing when the external projector outputs a sound. Thus, a lag between the sounds outputted from the projector and the external projector can be restrained.

Still another aspect of the invention is directed to a method for controlling a projection system including a plurality of projectors connected in a daisy chain, each of the projectors projecting an image, the method including: transmitting an audio signal from one of the projectors forming the daisy chain to the projector placed subsequently in an order of connection; outputting delay information representing a delay in one of the projectors to the projector placed further down in the order of connection; and at a timing corresponding to a delay in one of the projectors, causing one or more of the other projectors to output a sound based on the audio signal.

According to the aspect of the invention, the timing when one or more of the other projectors output a sound can be made coincident with the timing when one of the projectors outputs a sound. Thus, a lag between the sounds outputted from the respective projectors can be restrained.

Still another aspect of the invention is directed to a method for controlling a projection system including a plurality of projectors connected in a daisy chain, each of the projectors projecting an image, the method including: transmitting an image signal and an audio signal from one of the projectors forming the daisy chain to the projector placed subsequently in an order of connection; outputting delay information representing a delay in one of the projectors to the projector placed further down in the order of connection; and causing one of the projectors to output a sound based on the audio signal, according to a time difference between a timing when the image signal is inputted to one of the projectors and a timing when the image signal is inputted to the projector placed subsequently in the order of connection.

According to the aspect of the invention, the timing when each of the projectors outputs a sound can be made coincident with the timing when the projector placed last in the order of connection outputs a sound. Thus, a lag between the sounds outputted from the respective projectors can be restrained.

### BRIEF DESCRIPTION OF THE DRAWINGS

The invention will be described with reference to the accompanying drawings, wherein like numbers reference like elements.

FIG. 1 is a system configuration diagram showing an outline of a projection system.

FIG. 2 shows the configuration of an image supply device.

FIG. 3 shows the configuration of a projector.

FIG. 4 is a sequence chart showing operations of the projection system.

FIG. 5 is a flowchart showing operations of the projector.

FIG. 6 shows the configuration of a table.

### DESCRIPTION OF EXEMPLARY EMBODIMENTS

Hereinafter, an embodiment of the invention will be described with reference to the accompanying drawings.

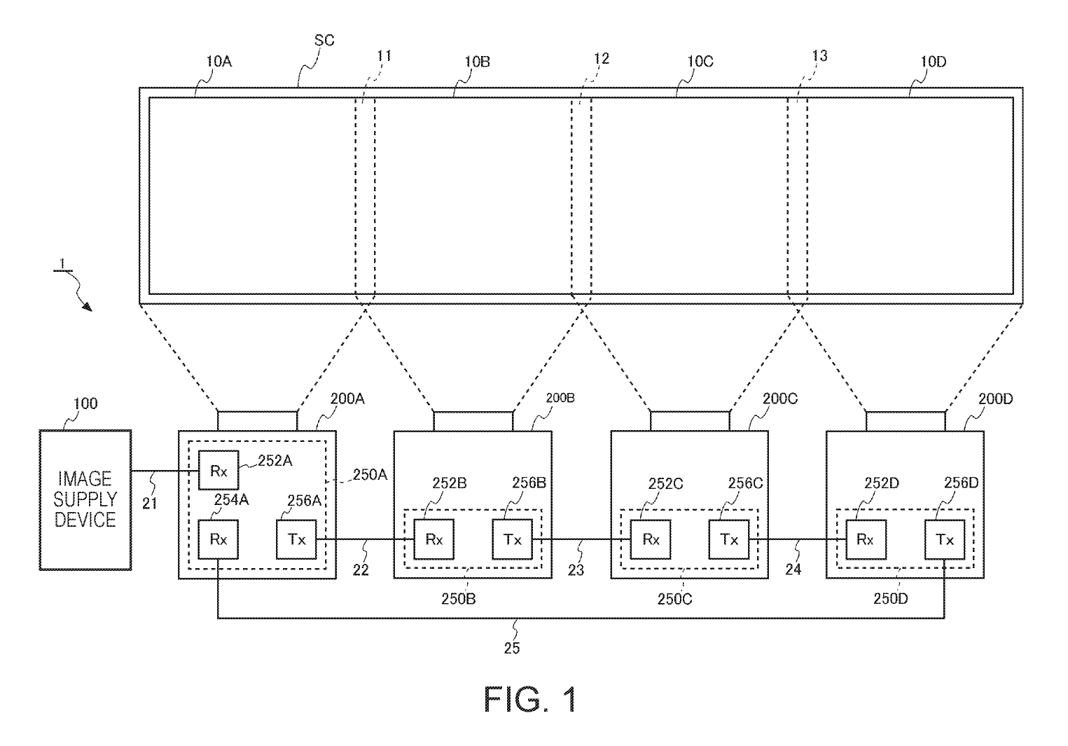

FIG. 1 is a system configuration diagram of an embodiment to which the invention is applied.

A projection system 1 in this embodiment includes an image supply device 100 and a plurality of projectors 200. In FIG. 1, four projectors 200A, 200B, 200C, 200D are shown as a plurality of projectors 200. However, the number of projectors 200 forming the projection system 1 is not limited to four. In the description below, the term “projector (s) 200” is used unless the projectors 200A, 200B, 200C, 200D need to be discriminated from each other. The projector 200A is equivalent to the “projector placed first in the order of connection” according to the invention. The projector 200D is equivalent to the “projector placed last in the order of connection” according to the invention.

The image supply device 100 is connected to the projector 200A. The image supply device 100 supplies an HDMI (trademark registered) signal to the projector 200A. The HDMI signal includes image data and audio data. The image data may be image data of a dynamic image or image data of a still image. The audio data may be monaural audio data or stereo (2-channel) audio data. The audio data may also be surround (5.1-channel or 7.1-channel) audio data using more audio channels than stereo (2-channel) audio data.

As the image supply device 100, for example, a notebook PC (personal computer), desktop PC, tablet terminal, smartphone, PDA (personal digital assistant) or the like can be used. Also, a video player, DVD (digital versatile disk) player, Blu-ray disc player, hard disk recorder, television tuner device, CATV (cable television) set top box, video game machine or the like may be used as the image supply device 100.

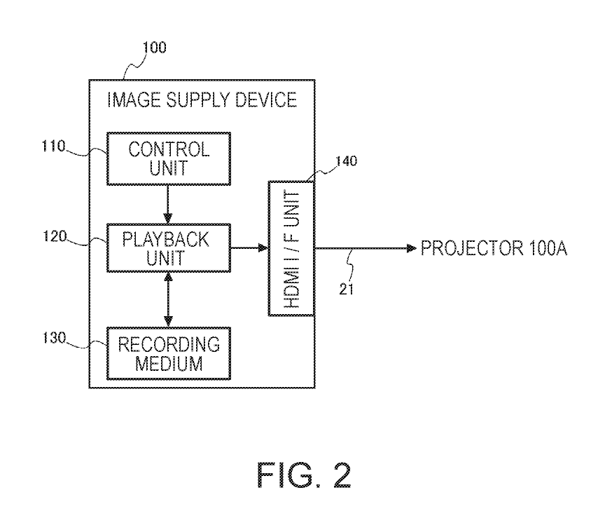

FIG. 2 shows the configuration of the image supply device 100.

The image supply device 100 includes a control unit 110, a playback unit 120, a recording medium 130, and an HDMI (trademark registered) interface (hereinafter abbreviated as I/F) unit 140. The control unit 110 controls the image supply device 100. The playback unit 120 plays back content recorded in the recording medium 130 such as a DVD or Blu-ray (trademark registered) disc, under the control of the control unit 110. The playback unit 120 also outputs image data and audio data of the played-back content to the HDMI I/F unit 140.

The HDMI I/F unit 140 is connected to an HDMI cable 21. The HDMI cable 21 has one end connected to the HDMI I/F unit 140 and the other end connected to an HDMI I/F unit 250A of the projector 200A. The HDMI I/F unit 140 converts incoming image data and audio data into an HDMI signal in a predetermined transmission format under the control of the control unit 110. The HDMI I/F unit 140 outputs the HDMI signal to the HDMI cable 21 under the control of the control unit 110.

The playback unit 120 may also play back content stored in a semiconductor storage device such as a flash memory, a magnetic storage device such as an HDD, or a magneto-optical storage device. Also, a configuration in which the playback unit 120 plays back content downloaded from a server device on a network may be employed.

The projectors 200A, 200B, 200C, and 200D are daisy-chained via HDMI cables 22, 23, 24. The projector 200B is connected to the projector 200A via the HDMI cable 22. The projector 200C is connected to the projector 200B via the HDMI cable 23. The projector 200D is connected to the projector 200C via the HDMI cable 24. The projector 200A, and the projector 200D placed at the terminal end, are connected to each other via an HDMI cable 25.

The projector 200A has the HDMI I/F unit 250A. The HDMI I/F unit 250A includes HDMI receiving units 252A, 254A and an HDMI transmitting unit 256A. In FIG. 1, the HDMI receiving units are illustrated as “Rx” and the HDMI transmitting unit is illustrated as “Tx”.

The HDMI receiving unit 252A is connected to the image supply device 100 via the HDMI cable 21. The HDMI receiving unit 254A is connected to the projector 200D via the HDMI cable 25. The HDMI transmitting unit 256A is connected to the projector 200B via the HDMI cable 22. The HDMI receiving unit 252A is equivalent to the “input unit” according to the invention. The HDMI transmitting unit 256A is equivalent to the “signal output unit” according to the invention.

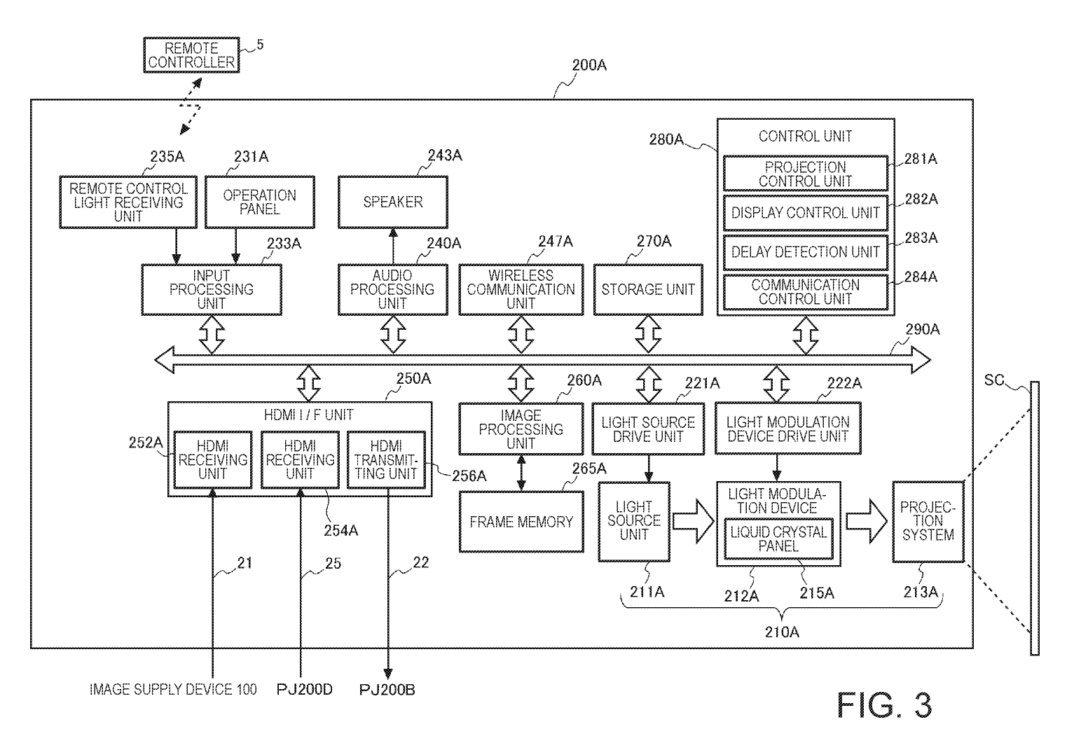

In the projector 200A, the HDMI receiving unit 252A receives an HDMI signal transmitted from the image supply device 100. The projector 200A takes in the received HDMI signal, and an image processing unit 260A (see FIG. 3) and an audio processing unit 240A (see FIG. 3) within the projector 200A process the HDMI signal. In the projector 200A, the HDMI transmitting unit 256A transmits the HDMI signal to the projector 200B. In the projector 200A, the HDMI receiving unit 254A receives an HDMI signal transmitted from the projector 200D.

The projector 200B has an HDMI I/F unit 250B. The HDMI I/F unit 250B includes an HDMI receiving unit 252B and an HDMI transmitting unit 256B. The HDMI receiving unit 252B is connected to the projector 200A via the HDMI cable 22. The HDMI transmitting unit 256B is connected to the projector 200C via the HDMI cable 23. The HDMI receiving unit 252B is equivalent to the “input unit” according to the invention. The HDMI transmitting unit 256B is equivalent to the “signal output unit” according to the invention.

In the projector 200B, the HDMI receiving unit 252B receives the HDMI signal transmitted from the projector 200A. The projector 200B takes in the received HDMI signal, and an image processing unit 260B and an audio processing unit 240B (neither of which is illustrated) within the projector 200B process the HDMI signal. In the projector 200B, the HDMI transmitting unit 256B transmits the HDMI signal to the projector 200C.

The projector 200C has an HDMI I/F unit 250C. The HDMI I/F unit 250C includes an HDMI receiving unit 252C and an HDMI transmitting unit 256C. The HDMI receiving unit 252C is connected to the projector 200B via the HDMI cable 23. The HDMI transmitting unit 256C is connected to the projector 200D via the HDMI cable 24. The HDMI receiving unit 252C is equivalent to the “input unit” according to the invention. The HDMI transmitting unit 256C is equivalent to the “signal output unit” according to the invention.

In the projector 200C, the HDMI receiving unit 252C receives the HDMI signal transmitted from the projector 200B. The projector 200C takes in the received HDMI signal, and an image processing unit 260C and an audio processing unit 240C (neither of which is illustrated) within the projector 200C process the HDMI signal. In the projector 200C, the HDMI transmitting unit 256C transmits the HDMI signal to the projector 200D.

The projector 200D has an HDMI I/F unit 250D. The HDMI I/F unit 250D includes an HDMI receiving unit 252D and an HDMI transmitting unit 256D. The HDMI receiving unit 252D is connected to the projector 200C via the HDMI cable 24. The HDMI transmitting unit 256D is connected to the projector 200A via the HDMI cable 25. The HDMI receiving unit 252D is equivalent to the “input unit” according to the invention. The HDMI transmitting unit 256D is equivalent to the “signal output unit” according to the invention.

In the projector 200D, the HDMI receiving unit 252D receives the HDMI signal transmitted from the projector 200C. The projector 200D takes in the received HDMI signal, and an image processing unit 260D and an audio processing unit 240D (neither of which is illustrated) within the projector 200D process the HDMI signal. In the projector 200D, the HDMI transmitting unit 256D transmits the HDMI signal to the projector 200A.

The HDMI cables 21, 22, 23, 24, and 25 have a data line for transmitting image data, audio data, and control information. This data line includes three data lines of TMDS (transition minimized differential signaling) channels #0, #1, #2. These data lines serially transmit an HDMI signal, which is a differential signal, in one direction. The HDMI cables 21, 22, 23, 24, and 25 also have a CEC (consumer electronic control) line and a DDC (display data channel) line. The CEC line is a signal line which communicates control data bidirectionally between devices connected to the HDMI cables. The DDC line includes two signal lines used to read out E-EDID (enhanced extended display identification data). The E-EDID is device information to specify a sink device, which is a device on the side receiving the HDMI signal supplied. Between the image supply device 100 and the projector 200A connected to the HDMI cable 21, the projector 200A operates as the sink device. Between the projector 200A and the projector 200B connected to the HDMI cable 22, the projector 200B operates as the sink device. Between the projector 200B and the projector 200C connected to the HDMI cable 23, the projector 200C operates as the sink device. Between the projector 200C and the projector 200D connected to the HDMI cable 24, the projector 200D operates as the sink device. Between the projector 200D and the projector 200A connected to the HDMI cable 25, the projector 200A operates as the sink device.

FIG. 1 shows the case where the projectors 200A, 200B, 200C, 200D are arranged in a horizontal line and where the respective projectors 200 project images in a horizontal juxtaposition on a screen SC. The projector 200A projects an image in a projection area 10A of the screen SC. The projector 200B projects an image in a projection area 10B of the screen SC. The projector 200C projects an image in a projection area 10C of the screen SC. The projector 200D projects an image in a projection area 10D of the screen SC.

The projection system 1 carries out tiled projection in which the images projected by the projectors 200A, 200B, 200C, 200D are combined together on the screen SC, thus forming a single large-screen image on the screen SC. That is, in tiled projection, the projectors 200 next to each other are arranged in such a way that the images projected by projection units 210 are combined together on the screen SC. In this embodiment, the projectors 200A and 200B, the projectors 200B and 200C, and the projectors 200C and 200D are equivalent to the projectors 200 next to each other.

In tiled projection, the projectors 200 project images in such a way that an edge of the image projected by each projector 200 overlaps an edge of the image projected by the next projector 200. This is for the purpose of obscuring the boundary between the projected images. For example, an edge of the image projected by the projector 200A and an edge of the image projected by the projector 200B situated to the right overlap each other, forming an overlap area 11. Similarly, an edge of the image projected by the projector 200B and an edge of the image projected by the projector 200C situated to the right overlap each other, forming an overlap area 12. Similarly, an edge of the image projected by the projector 200C and an edge of the image projected by the projector 200D situated to the right overlap each other, forming an overlap area 13.

While this embodiment describes an example where the projection target for the projectors 200A to 200D to project images on is the screen SC (projection surface), the projection target is not limited to the screen SC. The projection target may be a uniform flat surface, a curved surface, a discontinuous or uneven surface, or the like. Specifically, a wall surface of a building or a surface of an object can be used as the projection target.

The method for installing the projectors 200A to 200D is not limited to horizontal placing. Ceiling suspension, in which the projectors 200A to 200D are suspended from the ceiling, or wall hanging, in which the projectors 200A to 200D are hung on the wall surface, can also be employed.

While FIG. 1 shows the case where the projectors 200A to 200D are arranged in a horizontal line, the projectors 200A to 200D may be arranged in a vertical line. The projectors 200A to 200D may also be arranged in two rows by two columns.

FIG. 3 shows the configuration of the projector 200A. The projector 200A has a different configuration from the projectors 200B and 200C in that the HDMI I/F unit 250A has the two HDMI receiving units 252A and 254A. However, the other parts of the configuration are the same among the projectors 200A to 200C. Therefore, the configuration of the projector 200A is described as a representative example.

In the description below, in order to discriminate functional blocks of each projector 200, functional blocks of the projector 200A are denoted by the symbol “A” and functional blocks of the projector 200B are denoted by the symbol “B”. Similarly, functional blocks of the projector 200C are denoted by the symbol “C” and functional blocks of the projector 200D are denoted by the symbol “D”. For example, the control unit of the projector 200A is described as a control unit 280A, and the control unit of the projector 200B is described as a control unit 280B. Similarly, the control unit of the projector 200C is described as a control unit 280C, and the control unit of the projector 200D is described as a control unit 280D.

The HDMI I/F unit 250A of the projector 200A has the HDMI receiving units 252A, 254A and the HDMI transmitting unit 256A.

The HDMI receiving units 252A and 254A each have a connection terminal to connect to the HDMI cables 21, 25, respectively, and an interface circuit which processes a received HDMI signal and converts the HDMI signal into image data, audio data, and control information.

The HDMI transmitting unit 256A has a connection terminal to connect to the HDMI cable 22, and an interface circuit which converts image data, audio data, and control information into an HDMI signal.

The projector 200A has a projection unit 210A which forms an optical image and projects the image on the screen SC. The projection unit 210A has a light source unit 211A, a light modulation device 212A, and a projection system 213A.

The light source unit 211A has a light source made up of a xenon lamp, ultra-high-pressure mercury lamp, LED (light emitting diode), laser light source or the like. The light source unit 211A may have a reflector and an auxiliary reflector to guide the light emitted from the light source to the light modulation device 212A. The light source unit 211A may further include a lens group to enhance optical characteristics of projection light, a polarizer, or a light adjustment device or the like to reduce the amount of light of the light emitted from the light source, on the path to the light modulation device 212A (though none of these components is illustrated).

The light source unit 211A is driven by a light source drive unit 221A. The light source drive unit 221A is connected to an internal bus 290A and turns on and off the light source of the light source unit 211A under the control of the control unit 280A similarly connected to the internal bus 290A.

The light modulation device 212A has, for example, three liquid crystal panels 215A corresponding to the primary colors of R (red), G (green), and B (blue). That is, the light modulation device 212A has a liquid crystal panel 215A corresponding to R (red) color light, a liquid crystal panel 215A corresponding to G (green) color light, and a liquid crystal panel 215A corresponding to B (blue) color light. The light emitted from the light source unit 211A is split into color lights of the three colors of RGB. Each of the color lights becomes incident respectively on the corresponding liquid crystal panel 215A. The three liquid crystal panels 215A are transmission-type liquid crystal panels, which modulate the light transmitted through the liquid crystal panels and thus generate image light. The image lights transmitted through and modulated by the respective liquid crystal panels 215A are combined by a light combining system such as a dichroic prism and exit to the projection system 213A.

The light modulation device 212A is driven by a light modulation device drive unit 222A. The light modulation device drive unit 222A is connected to the internal bus 290A.

Image data corresponding to the respective primary colors of R, G, B is inputted to the light modulation device drive unit 222A from the image processing unit 260A. The light modulation device drive unit 222A converts the inputted image data into a data signal suitable for the operation of the liquid crystal panels 215A. The light modulation device drive unit 222A applies a voltage to each pixel in each liquid crystal panel 215A, based on the converted data signal, and thus causes an image to be drawn on each liquid crystal panel 215A.

The projection system 213A has a lens group which projects the image light modulated by the light modulation device 212A onto the screen SC, thus forming an image on the screen SC. The projection system 213A may also include a zoom mechanism to enlarge or reduce the image projected on the screen SC, and a focus adjustment mechanism to adjust the focusing.

The projector 200A has an operation panel 231A, a remote control light receiving unit 235A, and an input processing unit 233A. The operation panel 231A and the remote control light receiving unit 235A are connected to the input processing unit 233A connected to the internal bus 290A.

The operation panel 231A is provided with various operation keys to operate the projector 200A. The operation panel 231A is provided, for example, with a power key to designate the power-on or power-off of the projector 200A, a menu key to carry out various settings, and the like. When an operation key is operated, the input processing unit 233A outputs an operation signal corresponding to the operated key to the control unit 280A.

The projector 200A also has a remote controller 5 which is used by a user. The remote controller 5 has various buttons and transmits an infrared signal corresponding to the operation of these buttons.

The remote control light receiving unit 235A receives the infrared signal transmitted from the remote controller 5. The input processing unit 233A decodes the infrared signal received by the remote control light receiving unit 235A, thus generates an operation signal indicating the content of the operation on the remote controller 5, and outputs the operation signal to the control unit 280A.

The projector 200A has an audio processing unit 240A and a speaker 243A. The audio processing unit 240A and the speaker 243A are equivalent to the “audio output unit” according to the invention.

The audio processing unit 240A performs signal processing on audio data, such as decoding, D/A conversion, and amplifying, and thus converts the audio data into an analog audio signal and outputs the analog audio signal to the speaker 243A.

The projector 200A has a wireless communication unit 247A. The wireless communication unit 247A is connected to the internal bus 290A and operates under the control of the control unit 280A.

The wireless communication unit 247A has an antenna and an RF (radio frequency) circuit or the like, not illustrated, and executes wireless communication with an external device under the control of the control unit 280A. As the wireless communication method of the wireless communication unit 247A, for example, a short-range wireless communication method can be employed, such as wireless LAN (local area network), Bluetooth (trademark registered), UWB (ultra wide band), or infrared communication. Also, a wireless communication method using a mobile phone network can be employed as the wireless communication method of the wireless communication unit 247A.

The projector 200A has an image processing system. The image processing system is made up mainly of the control unit 280A comprehensively controlling the entirety of the projector 200A and also includes the image processing unit 260A, a frame memory 265A, and a storage unit 270A. The control unit 280A, the image processing unit 260A, and the storage unit 270A are connected to each other via the internal bus 290A in such a way as to be able to communicate data.

The image processing unit 260A loads image data received from the image supply device 100 into the frame memory 265A and processes the image data. The processing carried out by the image processing unit 260A includes, for example, resolution conversion (scaling) or resizing, shape correction such as distortion correction, digital zoom, color tone correction, luminance correction and the like. The image processing unit 260A executes processing designated by the control unit 280A, and carries out the processing using a parameter inputted from the control unit 280A according to need. Of course, the image processing unit 260A can also execute a combination of a plurality of types from among the foregoing processing. The image processing unit 260A reads out from the frame memory 265A the image data with which the processing is finished, and outputs the image data to the light modulation device drive unit 222A.

The storage unit 270A is, for example, an auxiliary storage device such as a hard disk device. The storage unit 270A may be replaced by a DRAM (dynamic RAM), or a flash memory or an optical disc such as a CD (compact disc), DVD (digital versatile disc) or BD (Blu-ray disc) capable of storing a large volume of information. The storage unit 270A stores a control program executed by the control unit 280A and various data.

The storage unit 270A also stores identification information of the projectors 200A, 200B, 200C, 200D. The same applies to the storage units 270B, 270C, 270D. The identification information of each projector 200 may be inputted by the user operating the operation panel 231A. Alternatively, device information of each projector 200 read out from the E-EDID via the DDC line may be used.

The control unit 280A has, as its hardware, a CPU, a ROM, and a RAM (none of which is illustrated), and other peripheral circuits (none of which is illustrated), and controls each part of the projector 200. The ROM is a non-volatile storage device such as a flash ROM and stores a control program and data. The RAM is used as a work area when the CPU carries out arithmetic processing. The CPU loads the control program read out from the ROM or the storage unit 270A into the RAM, executes the loaded control program, and thus controls each part of the projector 200A.

The control unit 280A has, as its functional blocks, a projection control unit 281A, a display control unit 282A, a delay detection unit 283A, and a communication control unit 284A. The communication control unit 284A is equivalent to the “delay information output unit” according to the invention. The delay detection unit 283A is equivalent to the “delay detection unit” and the “audio output control unit” according to the invention. These functional blocks represent, in the form of blocks for the sake of convenience, the functions implemented by the CPU executing arithmetic processing according to the control program and do not represent any particular application or hardware.

The projection control unit 281A controls each part of the projector 200A and causes the projector 200A to display an image on the screen SC. For example, the projection control unit 281A controls the light modulation device drive unit 222A and causes an image based on image data to be drawn on the liquid crystal panel 215A. The projection control unit 281A also controls the light source drive unit 221A, thus controls the switching on and off of the light source of the light source unit 211A, and also adjusts the luminance of the light sources.

The display control unit 282A controls the image processing unit 260A and thus causes the image processing unit 260A to execute image processing.

For example, the display control unit 282A generates a thumbnail of image data stored in the storage unit 270A and causes the operation panel 231A to display the thumbnail. When image data is selected by an operation on the operation panel 231A or the remote controller 5, the display control unit 282A reads out the selected image data from the storage unit 270A and outputs the image data to the image processing unit 260A. At this point, the display control unit 282A outputs to the image processing unit 260A an instruction on the image processing to be executed by the image processing unit 260A and a necessary parameter for the image processing to be executed. The display control unit 282A also generates data of an operation screen to be displayed on the operation panel 231A or a GUI (graphical user interface) screen where operation buttons are displayed, and causes the operation panel 231A to display the operation screen or the GUI screen.

The display control unit 282A also generates range information based on arrangement information received from the preceding device (in the case of the projector 200A, from the image supply device 100). In tiled projection to project one large-screen image on the screen SC, image data is divided into a plurality of parts and each resulting part of the divided image data is projected by each of the projectors 200 forming the projection system 1. The range information is information representing the range of image data projected by the projector 200A, of the range of the divided image data.

Similarly, in the projectors 200B to 200D, the respective display control units 282B to 282D generate range information representing the range of image data projected by the respective projectors 200B to 200D, based on the arrangement information.

The arrangement information includes information such as the number of projectors connected, connection form (topology), position information of the projector 200 placed at the leading end, and a counter value, or the like.

The number of projectors connected is information of the number of the projectors 200 connected in a daisy chain. The number of projectors connected in this embodiment is four, that is, the projectors 200A, 200B, 200C, and 200D.

The connection form is information representing the form of daisy-chain connection. The connection form may be, for example, arranging a plurality of projectors 200 in a horizontal line, arranging a plurality of projectors 200 in a vertical line, arranging a plurality of projectors 200 in N rows by M columns (N and M being arbitrary natural numbers), and the like.

The position information of the projector 200 placed at the leading end is information representing the position of the projector 200 connected to the image supply device 100. In this embodiment, since the projector 200A is connected to the image supply device 100, the position information is “left”. If the projector 200D is connected to the image supply device 100, the position information is “right”. If the projector 200B is connected to the image supply device 100, the position information is “second from the left”. If the projector 200C is connected to the image supply device 100, the position information is “second from the right”.

If a plurality of projectors 200 is arranged in a vertical line, the position information may be, for example, “top”, “bottom”, “second from the top”, “second from the bottom” or the like. Meanwhile, if a plurality of projectors 200 is arranged in N rows by M columns, the position information may be, for example, “second from the top and third from the left” or the like.

The counter value is information specifying the position of each projector 200.

For example, the image supply device 100 outputs arrangement information including a counter with its value set to “0”, to the projector 200A. The display control unit 282A of the projector 200A determines that the position of the projector 200A is the leading end because the counter value included in the arrangement information is “0”. The display control unit 282A adds “1” to the counter value and outputs arrangement information including the counter with its value set to “1”, to the projector 200B. The display control unit 282B of the projector 200B determines that the position of the projector 200B is the second from the leading end because the counter value included in the arrangement information is “1”.

Similarly, the display control units 282B, 282C add “1” to the counter value and output arrangement information including the counter with its value set to “2”, “3”, respectively, to the subsequent projectors 200C, 200D. The subsequent projectors 200C, 200D, to which the arrangement information is inputted, determine their own positions based on the counter value. The projector 200D, which is the projector 200 in the last place, determines that the projector 200D is the projector 200 in the last place, based on the counter value and the information of the number of projectors connected.

The display control unit 282A generates range information, based on the number of projectors connected, the connection form, the counter value or the like included in the arrangement information. In this embodiment, the connection form of arranging the four projectors 200 in a horizontal line is employed, and the projector 200A is placed at the left end of the projection system 1. Therefore, the display control unit 282A determines the leftmost range as its range information, from among the four ranges resulting from quartering image data in a direction parallel to the vertical direction of the image data, and generates range information representing this range.

The display control unit 282A outputs the generated range information to the image processing unit 260A when causing the image processing unit 260A to process the image data, that is, before the projection of the image is started. When the image data received by the HDMI I/F unit 250A is inputted to the image processing unit 260A, the image processing unit 260A slices out the range represented by the range information from the inputted image data and carries out image processing on the image data in the range thus sliced out.

The delay detection unit 283A measures a delay time. Specifically, delay detection unit 283A measures, as the delay time, the time from when the HDMI I/F unit 250A receives an HDMI signal from the image supply device 100 to when the HDMI I/F unit 250A outputs the HDMI signal to the subsequent projector 200B. Details of the operation of the delay detection unit 283A will be described later.

The communication control unit 284A controls the HDMI I/F unit 250A and communicates with the image supply device 100 and each projector 200.

The projection system 1 in the embodiment is a system that reduces a lag between the sounds outputted from the respective projectors 200 and thus can play back multi-channel audio data.

The projection system 1 having a plurality of projectors 200 daisy-chained is configured to transmit an HDMI signal sequentially from a preceding projector 200 to the subsequent projector 200. Therefore, the timing when the HDMI signal is inputted to each projector 200 differs. If the projection system is configured in such a way that each projector 200 processes and plays back the inputted HDMI signal directly, a lag may be generated between images and sounds played back by the respective projectors 200. Particularly in tiled projection to project one image by a plurality of projectors 200, a lag in the image may be perceptible. If multi-channel audio data is played back, a lag in the sound may be perceptible.

The projector 200 to which the HDMI signal is inputted at the latest timing is the projector 200D placed last in the projection system 1. Therefore, control is performed so that the image and audio playback timings of the projectors 200A, 200B, and 200C placed in positions preceding the projector 200D become coincident with the playback timing of the projector 200D.

Specifically, each of the projectors 200A, 200B, and 200C is made to measure a delay time (internal delay) from when the HDMI is inputted to when the HDMI signal is outputted to the subsequent projector 200. Here, the delay time of the projector 200A is referred to as a delay time D1. The delay time of the projector 200B is referred to as a delay time D2. The delay time of the projector 200C is referred to as a delay time D3.

The projectors 200A to 200C output a sound from the speakers 243A to 243C, corresponding to the time difference between when the HDMI signal is inputted to each of the projectors 200A to 200C and when the HDMI signal is inputted to the last-placed projector 200D.

Each of the projectors 200A, 200B, and 200C decides the timing when each of the projectors 200A, 200B, and 200C starts playing back the image and sound, based on the measured delay time.

The timing when the HDMI signal is inputted to the projector 200C is earlier than the timing when the HDMI signal is inputted to the projector 200D, by the delay time D3 of the projector 200C. Therefore, the image and sound playback timing of the projector 200C is delayed by the delay time D3.

The timing when the HDMI signal is inputted to the projector 200B is earlier than the timing when the HDMI signal is inputted to the projector 200D, by the delay time D2 of the projector 200B and the delay time D3 of the projector 200C. Therefore, the image and sound playback timing of the projector 200B is delayed by the delay time D2+D3.

The timing when the HDMI signal is inputted to the projector 200A is earlier than the timing when the HDMI signal is inputted to the projector 200D, by the delay time D1+D2+D3. Therefore, the image and sound playback timing of the projector 200A is delayed by the delay time D1+D2+D3.

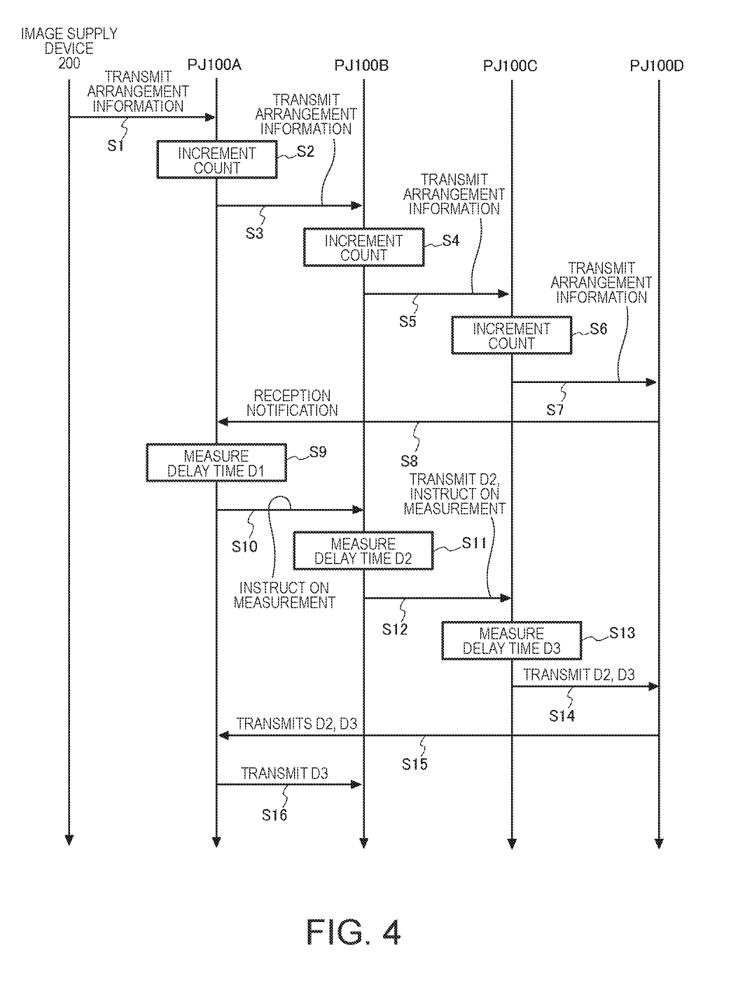

FIG. 4 is a sequence chart showing operations of the projection system 1.

First, the image supply device 100 transmits arrangement information to the projector 200A (step S1). On receiving the arrangement information from the image supply device 100, the communication control unit 284A of the projector 200A causes the received arrangement information to be stored in the memory. The communication control unit 284A of the projector 200A also adds “1” to the counter value included in the arrangement information and thus increments the counter value (step S2). The projector 200A transmits the arrangement information including the counter with “1” added to its value, to the projector 200B (step S3).

The communication control unit 284B of the projector 200B receives the arrangement information from the projector 200A. The communication control unit 284B of the projector 200B causes the received arrangement information to be stored in the memory. The communication control unit 284B of the projector 200B also adds “1” to the counter value included in the received arrangement information and thus increments the counter value (step S4). The projector 200B transmits the arrangement information including the counter with its value changed, to the projector 200C (step S5).

The communication control unit 284C of the projector 200C receives the arrangement information from the projector 200B. The communication control unit 284C of the projector 200C causes the received arrangement information to be stored in the memory. The communication control unit 284C of the projector 200C also adds “1” to the counter value included in the received arrangement information and thus increments the counter value (step S6). The communication control unit 284C of the projector 200C transmits the arrangement information including the counter with its value changed, to the projector 200D (step S7).

On receiving the arrangement information from the projector 200C, the communication control unit 284D of the projector 200D transmits a reception notification indicating that the arrangement information has been received, to the projector 200A (step S8).

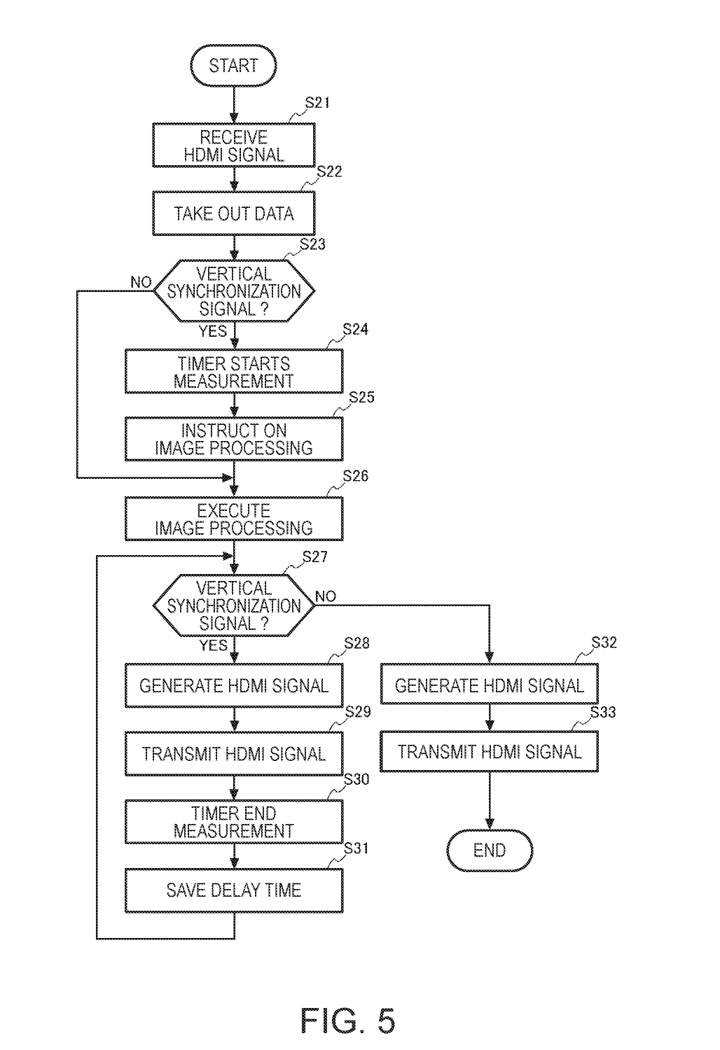

On receiving the reception notification from the projector 200D, the delay detection unit 283A of the projector 200A starts measuring the delay time D1. FIG. 5 is a flowchart showing procedures for measuring the delay time D1 of the projector 200A. The procedures for measuring the delay time D1 of the projector 200A will be described below, referring to the flowchart of FIG. 5.

The image supply device 100 transmits an HDMI signal for the measurement of the delay time to the projector 200A at a preset time interval. The HDMI signal for the measurement includes image data, a vertical synchronization signal, a horizontal synchronization signal, audio data and the like. The image data and the audio data may be prepared in advance for the measurement of the delay time or may be generated by the image supply device 100, using image data recorded in the recording medium 130.

On receiving the HDMI signal by the HDMI receiving unit 252A (step S21), the projector 200A carries out processing such as conversion from serial data to parallel data and decoding and thus takes out digital data superimposed on the HDMI signal (step S22).

Next, the HDMI I/F unit 250A determines whether the digital data thus taken out includes a vertical synchronization signal or not (step S23). If the digital data thus taken out does not include a vertical synchronization signal (NO in step S23), the HDMI I/F unit 250A shifts to the processing of step S26. Meanwhile, if the digital data thus taken out includes a vertical synchronization signal (YES in step S23), the HDMI I/F unit 250A outputs an interrupt signal to the delay detection unit 283A. On having the interrupt signal inputted from the HDMI I/F unit 250A, the delay detection unit 283A causes the timer to start measuring time (step S24). The delay detection unit 283A also instructs the image processing unit 260A to execute image processing (step S25).

The HDMI I/F unit 250A outputs image data taken out of an HDMI signal that is subsequently received, to the image processing unit 260A. If audio data is taken out of the HDMI signal, the HDMI I/F unit 250A outputs the audio data to the delay detection unit 283A. The delay detection unit 283A causes the inputted audio data to be stored in the memory.

On having the image data received from the HDMI I/F unit 250A, the image processing unit 260A carries out image processing on the inputted image data (step S26). The image processing carried out by the image processing unit 260A may be preset image processing or may be image processing corresponding to the type of the image data. The image processing carried out by the image processing unit 260A may be one type of processing or may be a combination of a plurality of types of processing, for example, digital zoom, color tone correction, and luminance correction.

As the image processing corresponding to the type of the image data, for example, the image processing unit 260A executes processing to carry out frame interpolation and generate an intermediate frame, if the image data inputted to the image processing unit 260A is image data in the film mode of 24 frames per second. After finishing the image processing, the image processing unit 260A outputs the image data with which the image processing has been finished, to the HDMI I/F unit 250A.

The delay detection unit 283A instructs the HDMI I/F unit 250A about the timing of insertion of a vertical synchronization signal and a horizontal synchronization signal. The delay detection unit 283A also gives an instruction to generate an HDMI signal including audio data during a blanking period when the image data is paused.

When instructed by the delay detection unit 283A about the insertion of a vertical synchronization signal, the HDMI I/F unit 250A carries out processing such as encoding and serial conversion of data including a vertical synchronization signal and thus generates an HDMI signal (step S28). The HDMI I/F unit 250A causes the HDMI transmitting unit 256A to transmit the generated HDMI signal to the projector 200B (step S29). When the transmission of the HDMI signal including the vertical synchronization signal ends, the HDMI I/F unit 250A outputs an interrupt signal to the control unit 280A.

The delay detection unit 283A causes the timer to end the measurement of time by having the interrupt signal inputted from the HDMI I/F unit 250A (step S30), and causes the time measured by the timer to be stored in the memory as the delay time D1 (step S31). The delay time measured by the delay detection unit 283A of the projector 200A is a time reflecting the time taken for the image processing executed by the image processing unit 260A. Similarly, the delay times measured in the projectors 200B and 200C are times reflecting the times taken for the image processing executed by the image processing units 260B, 260C. The delay times measured in the projectors 200A to 200C may include the times taken for processing other than the image processing executed by the image processing units.

Meanwhile, if there is no instruction about the insertion of a vertical synchronization signal (NO in step S27), the HDMI I/F unit 250A carries out processing such as encoding and serial conversion of the image data inputted from the image processing unit 260A and thus generates an HDMI signal (step S32). If instructed by the delay detection unit 283A about the generation of audio data, for example, the HDMI I/F unit 250A reads out audio data from the memory, carries out processing such as encoding and serial conversion, and thus generates an HDMI signal (step S32). The HDMI I/F unit 250A causes the HDMI transmitting unit 256A to transmit the generated HDMI signal to the projector 200B (step S33).

The description of the operations of the projection system 1 continues, referring to the sequence chart shown in FIG. 4.

When the measurement of the delay time D1 is finished, the projector 200A instructs the projector 200B to measure the delay time D2 (step S10). When instructed by the projector 200A about the measurement of the delay time D2, the projector 200B measures the delay time D2, following procedures similar to those of the projector 200A (step S11). As in the projector 200A, the delay detection unit 283B of the projector 200B causes the timer to start measurement at the timing when the HDMI signal including the vertical synchronization signal is inputted. The delay detection unit 283B causes the timer to finish measurement at the timing when the HDMI transmitting unit 256B outputs the HDMI signal including the vertical synchronization signal to the HDMI cable 23. The delay detection unit 283B then causes the measured time to be stored in the memory as the delay time D2.

The image data included in the HDMI signal received by the projector 200B is the image data on which image processing has been carried out by the projector 200A. For example, if the projector 200A generates an intermediate frame as image processing, the projector 200A transmits image data including the generated intermediate frame, as an HDMI signal, to the projector 200B. Therefore, the projector 200B receives the HDMI signal from the projector 200A and then takes out the vertical synchronization signal, horizontal synchronization signal, image data, audio data and the like from the received HDMI signal. The projector 200B generates an HDMI signal including the vertical synchronization signal, horizontal synchronization signal, image data, and audio data thus taken out, and causes the HDMI transmitting unit 256B to transmit the HDMI signal to the projector 200C.

The communication control unit 284B of the projector 200B transmits the measured delay time D2 to the projector 200C. The delay time D2 transmitted from the projector 200B to the projector 200C is equivalent to the “delay information” according to the invention. The communication control unit 284B of the projector 200B also instructs the projector 200C about the measurement of the delay time D3 (step S12).

When instructed by the projector 200B about the measurement of the delay time D3, the delay detection unit 283C of the projector 200C measures the delay time D3, following procedures similar to those of the projector 200A (step S13). As in the projector 200A, the delay detection unit 283C of the projector 200C causes the timer to start measurement at the timing when the HDMI signal including the vertical synchronization signal is inputted. The delay detection unit 283C causes the timer to finish measurement at the timing when the HDMI transmitting unit 256C outputs the HDMI signal including the vertical synchronization signal to the HDMI cable 24. The delay detection unit 283C defines the measured time as the delay time D3.

The image data included in the HDMI signal received by the projector 200C is the image data on which image processing has been carried out by the projector 200A. Therefore, the projector 200C receives the HDMI signal from the projector 200B and then takes out the vertical synchronization signal, horizontal synchronization signal, image data, audio data and the like from the received HDMI signal. The projector 200C generates an HDMI signal including the vertical synchronization signal, horizontal synchronization signal, image data, and audio data thus taken out, and causes the HDMI transmitting unit 256C to transmit the HDMI signal to the projector 200D.

The delay detection unit 283C of the projector 200C causes the measured delay time D3 to be stored in the memory. The communication control unit 284C transmits the measured delay time D3, and the delay time D2 measured by the projector 200B, to the projector 200D (step S14). The communication control unit 284C may transmit, to the projector 200D, the time resulting from adding the delay time D2 measured by the projector 200B to the measured delay time D3, as the delay time. Subsequently, the projector 200C receives the HDMI signal from the projector 200B and delays the timing of starting the playback of the image and sound taken out of the received HDMI signal, by the delay time D3.

The projector 200C is equivalent to the “one of the projectors” which outputs the delay times D2 and D3 as the delay information to the first-placed projector 200A.

The projector 200D receives the delay times D2 and D3 from the projector 200C and then transmits the received delay times D2 and D3 to the projector 200A (step S15).

The projector 200D, too, is equivalent to the “one of the projectors” which outputs the delay times D2 and D3 as the delay information to the first-placed projector 200A.

The projector 200A causes the time resulting from adding the received delay times D2 and D3 to the measured delay time D1, to be stored in the memory as the delay time. The projector 200A also transmits the delay time D3 measured by the projector 200C to the projector 200B (step S16). The projector 200B causes the time resulting from adding the received delay time D3 to the measured delay time D2, to be stored in the memory as the delay time.

Subsequently, the projector 200A, on receiving an HDMI signal from the image supply device 100, delays the timing of starting the playback of the image and sound taken out of the received HDMI signal, by the delay time D1+D2+D3.

The projector 200B, on receiving the HDMI signal from the projector 200A, delays the timing of starting the playback of the image and sound taken out of the received HDMI signal, by the delay time D2+D3.

The projector 200C, on receiving the HDMI signal from the projector 200B, delays the timing of starting the playback of the image and sound taken out of the received HDMI signal, by the delay time D3.

Thus, according to the timing when the projector 200D placed last in the order of connection outputs a sound, the projectors 200A to 200C other than the last-placed projector 200D can output a sound.

In a communication method conforming to the HDMI, audio data is transmitted, using a blanking period when the transmission of image data is paused. The playback timing of the audio data must be synchronized with the playback timing of the image data.

Thus, in each of the projectors 200A to 200C, the time taken for image processing executed by each of the image processing units 260A to 260C is measured as the delay time. Each of the projectors 200A to 200C outputs a sound at the timing corresponding to the measured delay time. Thus, the timings when the projectors 200A to 200C output a sound can be made coincident with the timing when the projector 200D outputs a sound.

As described above, this embodiment is applied to the projection system 1 having a plurality of projectors 200 daisy-chained. Each of the projectors 200 includes the HDMI receiving unit 252, the projection unit 210, the speaker 243, the HDMI transmitting unit 256, and the communication control unit 284.

An HDMI signal with image data and audio data superimposed thereon is inputted to the HDMI receiving unit 252. The projection unit 210 projects an image based on the inputted image data. The speaker 243 outputs the inputted audio data. The HDMI transmitting unit 256 outputs the inputted HDMI signal with the image data and audio data superimposed thereon, to the subsequent projector 200 in the order of connection. The communication control unit 284 outputs delay information representing the delay in the projector 200 to the other projectors 200.

Each of the projectors 200A to 200C outputs a sound from the speaker 243, corresponding to the time difference between the timing when an HDMI signal is inputted to each of the projectors 200A to 200C and the timing when an image signal is inputted to the last-placed projector 200D. Thus, a lag between the sounds outputted from the projectors 200 can be restrained.

Each projector 200 has the image processing unit 260, which executes image processing on the image data taken out of the received HDMI signal. The communication control unit 284 outputs delay information reflecting the time taken for the processing executed on the received image data by the image processing unit 260.

Thus, the time reflecting the time taken for the processing executed by the image processing unit 260 can be outputted as the delay time. This enables each projector 200 to output a sound at the timing reflecting the time taken for the processing executed by the image processing unit 260.

The communication control unit 284 also outputs delay information representing the time from when an HDMI signal is inputted to the HDMI receiving unit 252 to when the HDMI signal is outputted from the HDMI transmitting unit 256.

Thus, each of the projectors 200A to 200C can find the time difference from the timing when the HDMI signal is inputted to the last-placed projector 200D. This can more effectively restrain a lag between the sounds outputted from the projectors 200.

Each projector 200 also has the delay detection unit 283, which detects the delay time from when an HDMI signal is inputted to the HDMI receiving unit 252 to when the HDMI signal is outputted from the HDMI transmitting unit 256. The communication control unit 284 outputs delay information representing the delay time detected by the delay detection unit 283.

This enables each projector 200 to detect the delay time from when an HDMI signal is inputted to the HDMI receiving unit 252 to when the HDMI signal is outputted from the HDMI transmitting unit 256.

The communication control unit 284C of the projector 200C outputs delay information representing the time resulting from adding the time measured in the projector 200C to the time represented by the delay information outputted from the projector 200B.

Thus, the delay information reflecting the delay time of the preceding projector 200B can be outputted to the subsequent projector 200C.

The communication control unit 284B of the projector 200B or the communication control unit 284C of the projector 200C outputs the delay information to the first-placed projector 200A in the order of connection.

This enables the first-placed projector 200A to set the output timing of a sound, based on the delay information of the subsequent projectors 200B, 200C.

The projector 200B and the projector 200C output the delay information of the projectors 200B, 200C other than the first-placed projector 200A and the last-placed projector 200D in the order of connection, to the first-placed projector 200A.

Thus, the delay information of the projectors 200B, 200C necessary for the setting of the output timing of a sound in the first-placed projector 200A can be inputted to the projector 200A.

According to the timing when the projector 200D placed last in the order of connection outputs a sound based on an audio signal, the projectors 200A to 200C other than the last-placed projector 200D output a sound.

Thus, the timing when the projectors 200A to 200C, other than the last-placed projector 200D output a sound can be made coincident with the timing when the last-placed projector 200D outputs a sound.

The projectors 200 next to each other are arranged in such a way that images projected by the projection units 210 are combined together on the screen SC. The projectors 200 next to each other are the projectors 200A and 200B, the projectors 200B and 200C, and the projectors 200C and 200D.

Thus, images projected by the projectors 200 next to each other can be combined together on the screen SC.

Also, images projected by a plurality of projectors 200 connected in a predetermined order of connection are combined together on the screen SC.

Thus, images projected by a plurality of projectors 200 can be combined together on the screen SC.

### Second Embodiment

Next, a second embodiment of the invention will be described, referring to the accompanying drawings. Similarly to the first embodiment, this embodiment includes four projectors 200A, 200B, 200C, and 200D connected in a horizontal line. The configuration of each projector 200 is the same as the configuration of the projector 200A shown in FIG. 3. Therefore, the configuration of each projector 200 will not be described further.

The projection system 1 in the second embodiment carries out the processing of steps S1 to S8 in the sequence chart shown in FIG. 4 and does not carry out the processing of steps S9 to S16.

Each projector 200 determines the connection form of the projection system 1, its own position in that connection form, and the like, based on arrangement information received from the preceding device.

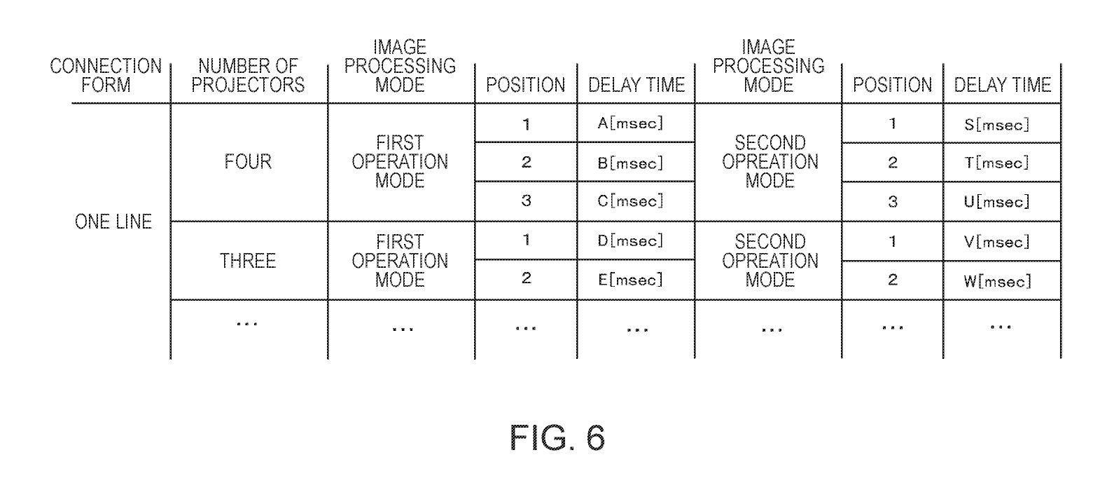

FIG. 6 shows the configuration of a table stored in the storage unit 270 of each projector 200.

The storage unit 270 of each projector 200 stores a table on which a delay time is registered for each connection form, number of projectors 200 connected, image processing mode (operation mode), and position. The delay times registered on this table may be prepared in advance before the shipment of the product, or may be registered in the projector 200 by the user following the procedures in the first embodiment.

As an operation mode, a combination of different types of image processing executed by the image processing unit 260 of each projector 200 is registered. For example, shape correction and color tone correction may be defined as a first operation mode, and resolution conversion and digital zoom may be defined as a second operation mode. The delay time in the case where a combination of the plurality of types of image processing is executed is registered on the table.

The delay detection unit 283 determines the connection form of the projection system 1, the position of the projector in that connection form, and the like, and then acquires information of delay information corresponding to the connection form and position thus determined and the operation mode of the image processing unit 260, referring to the table. The delay detection unit 283 is equivalent to the “control unit” according to the invention.

On receiving an HDMI signal from the image supply device 100, the delay detection unit 283 delays the timing of starting the playback of the image and sound taken out of the received HDMI signal, by the delay time acquired from the table.

This enables the speaker 243 to output a sound with the delay time corresponding to the order of connection and the operation mode of the image processing unit 260.

The embodiments are simply specific examples to which the invention is applied. The embodiments should not limit the invention. The invention can also be applied to different forms of embodiment.

For example, an interface conforming to the display port standard can be used as the interface provided for the image supply device 100 and the projectors 200, and a display port table can be used as the cable. Also, an interface conforming to the USB-Type C standard can be used as the interface provided for the image supply device 100 and the projector 200, and a cable conforming to the USB-Type C standard can be used as the cable.

In the embodiments, a configuration in which the light modulation device 212A has the liquid crystal panels 215A is described as an example. The liquid crystal panels 215A may be transmission-type liquid crystal panels or may be reflection-type liquid crystal panels. The light modulation device 212A may also be configured, using a digital mirror device (DMD) instead of the liquid crystal panels 215A. The light modulation device 212A may also be configured, using a combination of a digital mirror device and a color wheel. Moreover, the light modulation device 212A may employ a configuration capable of modulating the light emitted from the light source, other than the liquid crystal panels and DMD.

Each functional unit of the projector 200A shown in FIG. 3 shows a functional configuration and is not particularly limited to any specific form installation. That is, it is not necessary to install an individual piece of hardware corresponding to each functional unit. As a matter of course, a single processor may execute a program to implement the functions of a plurality of functional units. In the embodiments, a part of the functions implemented by software may be implemented by hardware, and a part of the functions implemented by hardware may be implemented by software. Also, specific details of the configuration of each of the other parts of the projector can be changed arbitrarily without departing from the spirit of the invention.

The units of processing in the flowchart shown in FIG. 5 are provided by dividing the processing according to main content of processing, in order to facilitate understanding of the processing in the projector 200A. The way the processing is divided into the units of processing shown in the flowchart of FIG. 5 and the names thereof should not limit the invention. According to the content of processing, the processing by the control unit 280A can be divided into a greater number of units of processing or can be divided in such a way that one unit of processing includes further processing. Also, the order of processing in the flowchart is not limited to the illustrated example.

In the projection system 1, to the projector 200A, the projectors 200B to 200D are equivalent to external projectors. Similarly, to the projector 200B, the projectors 200A, 200C, 200D are equivalent to external projectors. Similarly, to the projector 200C, the projectors 200A, 200B, 200D are equivalent to external projectors. Similarly, to the projector 200D, the projectors 200A to 200C are equivalent to external projectors.

What is claimed is:

1. A projection system including a plurality of projectors connected in a daisy chain,
each of the projectors comprising:
an input unit to which an image signal and an audio signal are inputted;
a projection unit which projects an image based on the image signal inputted to the input unit;
an audio output unit which outputs a sound based on the audio signal inputted to the input unit;
a signal output unit which outputs the image signal and the audio signal inputted to the input unit, to the projector placed subsequently in an order of connection; and
a delay information output unit which outputs delay information representing a delay in the projector to the other projectors,
wherein at a timing corresponding to a delay in one of the projectors forming the daisy chain, one or more of the other projectors cause the audio output unit to output a sound based on the audio signal.

2. The projection system according to claim 1, further comprising an image processing unit which executes image processing on the image signal inputted to the input unit,
wherein the delay information output unit outputs the delay information reflecting a time taken for the processing executed by the image processing unit on the image signal inputted to the input unit.

3. The projection system according to claim 1, wherein the delay information output unit outputs the delay information representing a time from when the image signal is inputted to the input unit to when the image signal is outputted by the signal output unit.

4. The projection system according to claim 3, wherein each of the projectors includes a delay detection unit which detects a delay time from when the image signal is inputted to the input unit to when the image signal is outputted by the signal output unit, and
the delay information output unit outputs the delay information representing the delay time detected by the delay detection unit.

5. The projection system according to claim 3, wherein one of the projectors causes the delay information output unit to output the delay information representing a time resulting from adding a time from when the image signal is inputted to the input unit to when the image signal is outputted by the signal output unit, to a time represented by the delay information outputted from the projector that precedes in the order of connection.

6. The projection system according to claim 5, wherein one of the projectors causes the delay information output unit to output the delay information to the projector placed first in the order of connection.

7. The projection system according to claim 6, wherein one of the projectors outputs the delay information of each of the projectors except the projectors placed first and last in the order of connection, to the projector placed first in the order of connection.

8. The projection system according to claim 1, wherein
each of the projectors includes an image processing unit which executes image processing on the image signal inputted to the input unit,
each of the projectors is configured to be able to switch between and execute a plurality of operation modes with different contents of processing by the image processing unit, and
each of the projectors includes
a storage unit storing a table on which a delay time is registered for each order of connection and for each of the plurality of operation modes, and
a control unit which causes the audio output unit to output a sound based on the audio signal inputted to the input unit, with the delay time corresponding to the order of connection and the operation mode of the image processing unit.

9. The projection system according to claim 1, wherein the projectors other than the projector placed last in the order of connection output a sound, according to a timing when the last-placed projector outputs a sound based on the audio signal.

10. The projection system according to claim 1, wherein the projectors next to each other are arranged in such a way that images projected by the projection units are combined together on a projection surface.

11. The projection system according to claim 1, wherein images projected by a plurality of the projectors connected in a predetermined order of connection are combined together on a projection surface.

12. A projector having a projection unit which projects an image, the projector comprising:
an input unit to which an audio signal is inputted;
an audio output unit which outputs a sound based on the audio signal inputted to the input unit;
a signal output unit which outputs the audio signal inputted to the input unit, to an external projector;
a delay information output unit which outputs delay information representing a delay in the projector to the external projector; and
an audio output control unit which decides, based on the delay information, a timing when the audio output unit and the external projector output a sound based on the audio signal.

13. A method for controlling a projection system including a plurality of projectors connected in a daisy chain, each of the projectors projecting an image, the method comprising:
transmitting an audio signal from one of the projectors forming the daisy chain to the projector placed subsequently in an order of connection;
outputting delay information representing a delay in one of the projectors to the projector placed further down in the order of connection; and
at a timing corresponding to a delay in one of the projectors, causing one or more of the other projectors to output a sound based on the audio signal.
